(19) United States
(12) Patent Application Publication
(10) Pub. No.: US 2008/0264708 A1
(43) Pub. Date: Oct. 30, 2008

(54) Mobile Telemedicine Vehicle

(75) Inventors: Jeff T. Grange, Yucaipa, CA (US); Stephen W. Corbett, Lake Arrowhead, CA (US)

Correspondence Address: SHELDON MAK ROSE & ANDERSON PC, 100 Corson Street, Third Floor, PASADENA, CA, 91103-3842, US

(73) Assignee: LOMA LINDA UNIVERSITY MEDICAL CENTER, Loma Linda, CA (US)

(21) Appl. No.: 12/067,547

(22) PCT Filed: Sep. 7, 2007
(86) PCT No.: PCT/US07/77931

§ 371 Date: Mar. 20, 2008

Related U.S. Application Data
(60) Provisional application No. 60/824,883, filed on Sep. 7, 2006.

(51) Int. Cl. B62D 31/00

(52) U.S. Cl. 180/89.1

(57) ABSTRACT

A mobile telemedicine device for use in disasters and emergency response comprising four or more wheels connected to a drive train and a main compartment. The main compartment comprises an interior portion and an exterior portion and a supplemental compartment connected to the main compartment. Communications ports are connected to the exterior, and the supplemental compartment. Patient care tables are located in the main compartment. A method for using an all terrain mobile telemedicine vehicle, first driving the mobile telemedicine device to a disaster or emergency location and lowering and deploying a vehicle from the storage compartment to search for patients in need of medical services.

### CROSS-REFERENCE TO RELATED APPLICATION

The present application claims the benefit of U.S. Provisional Patent Application No. 60/824,883, filed Sep. 7, 2006, entitled “Mobile Telemedicine Vehicle,” the contents of which are incorporated herein by reference in their entirety.

### FIELD

The invention pertains to the field of emergency telemedicine devices and more specifically to a mobile telemedicine vehicle that can carry supplementary telemedicine vehicles to remote locations for use in disasters and emergencies.

### BACKGROUND

There are numerous devices and methods for utilizing telemedicine, the delivery of medicine, clinical care, medical communications and medical information at a distance. Among these methods and devices are real time telemedicine (synchronous) and store-and-forward telemedicine (asynchronous).

Advantageously, real time telemedicine can be as simple as a telephone call or as complex as a robotic surgery. A telemedicine equipped vehicle such as, for example, an ambulance can project telemedicine into remote areas that do not have adequate medical facilities. Also, peripheral devices can be attached to computers or the video-conferencing equipment at a telemedicine base site or in the telemedicine equipped vehicle that aid in an interactive examination such as, for example, a teleotoscope that enables a remote physician to view inside a patient's ear or a telestethoscope that transmits the patient's heartbeat to the consulting remote physician to hear. Specialties that use telemedicine use a “tele” prefix such as, for example, telemedicine as applied by radiologists is called teleradiology and telemedicine as applied by cardiologists is termed as telecardiology.

Disadvantageously, real time telemedicine requires the presence of both a doctor and a patient at the same time, and an adequate wired or wireless communications link such as, for example, a digital subscriber line (DSL), between a remote location and a telemedicine base site for a real-time interaction to take place. Further, real time telemedicine video-conferencing equipment, that is, one of the most common forms of technologies used in synchronous telemedicine, requires a consistent high speed connection.

Further disadvantageously, during an emergency or a disaster such as, for example, an earthquake, a hurricane or a tsunami, the communications infrastructure real time telemedicine requires is disrupted or destroyed preventing the projecting of medical expertise in real time. Additionally, disasters such as, for example, earthquakes, disrupt or destroy the transportation infrastructure preventing traditional emergency vehicles such as, for example, an ambulance, from reaching a disaster affected area.

Store-and-forward telemedicine involves first acquiring medical data such as, for example, medical images or bio-signals and then transmitting the medical data to a doctor or a medical specialist at a later time for assessment off line.

Advantageously, the store-and-forward method does not require the presence of both parties at the same time. Further, records can be viewed at the convenience of a specialist or saved for future review.

Disadvantageously, during an emergency a backlog of the medical data can overwhelm the specialist leading to inadequate care and mis-diagnosis. Further, a delay in processing a patient's records can be detrimental to the patient's health or recovery.

Therefore, there exists a need for an all terrain mobile telemedicine vehicle that can carry supplementary telemedicine vehicles to remote locations for use in disasters and emergencies that does not rely on established communications infrastructure or established transportation infrastructure.

### SUMMARY

A mobile telemedicine device comprising four or more wheels connected to a drive train which is connected to an engine that provides the four or more wheels power from an engine simultaneously; a main compartment connected to the four or more wheels, the main compartment comprising an interior portion and an exterior portion; a supplemental compartment connected to the main compartment; one or more than one automatic leveling hydraulic jack connected to the exterior portion of the main compartment; one or more than one communications port connected to the exterior portion of the main compartment, and further connected to the supplemental compartment; one or more than one patient care table affixed to the interior portion of the main compartment; one or more than one communications center connected to the interior portion of the main compartment; and one or more than one patient bed affixed to the interior portion of the main compartment. The mobile telemedicine device where the four or more than four wheels are six wheels; and where the six wheels receive power from the engine simultaneously.

The mobile telemedicine device further comprising an access hatch located in the main compartment that provides access to the supplemental compartment and where the access hatch is large enough to allow a medical cot at least 200 cm long and 80 cm wide to transit. The mobile telemedicine device further comprising a trailer hitch attached to the supplemental compartment. The mobile telemedicine device where the supplemental compartment comprises one or more than one supplemental vehicle. The mobile telemedicine device where the one or more than one supplemental vehicle is selected from the group consisting of a motorcycle, a remote controlled helicopter and an ATV. The mobile telemedicine device where the remote controlled helicopter comprises video relay means for forward surveillance and search operations. The mobile telemedicine device where the one or more than one supplemental vehicle is equipped with one or more than one wired communications device, one or more than one wireless communications device or both one or more than one wired and one or more than one wireless communications device for transmitting information back to the mobile telemedicine device; and where the supplemental compartment comprises a hydraulic lift. The mobile telemedicine device where the supplemental compartment is a medical laboratory for conducting medical tests. The mobile telemedicine device where the supplemental compartment is an integrated radiology laboratory suite; and where one or more than one wall between the supplemental compartment and the main compartment comprises a lead shield, a lead lining or both a lead shield and a lead lining configured to protect the occupants of the mobile telemedicine device from radiation. The mobile telemedicine device where the one or more than one communication port is wireless. The mobile telemedicine device where the wireless communications device comprises radio frequency communications device; and, where the wireless communications device are satellite wireless communications device. The mobile telemedicine device where the one or more than one communications port is wired. The mobile telemedicine device where or the one or more than one communications port is both wired and wireless.

The mobile telemedicine device further comprising a door located on the main compartment that comprises a width between 80 cm to 100 cm; preferably where the door is at least 84 cm wide. The mobile telemedicine device where the interior portion of the main compartment comprises one or more than one flat panel display for displaying information; and, where the one or more than one flat panel display is attached to a wall on the interior portion of the main compartment with a pivoting wall mount. The mobile telemedicine device, where the one or more flat panel displays are two or more than two flat panel displays, and where two of the two or more than two flat panel displays are located opposite each other for clear viewing by medical staff. The mobile telemedicine device, where the one or more than one flat panel display can display an operational status, contents of one or more than one flat panel display, or both operational status and the contents of one or more than one flat panel display for monitoring patient status.

The mobile telemedicine device, further comprising one or more than one remotely controllable camera attached to the one or more than one flat panel display for remote viewing of the interior portion of the main compartment. The mobile telemedicine device, where the one or more than one patient care table comprises a telescopic arm that raises and lowers the one or more than one patient care table. The mobile telemedicine device, where the one or more than one patient care table is hingedly affixed to a wall in the interior portion of the main compartment. The mobile telemedicine device, where the one or more than one communications center comprises redundant computers and redundant satellite communication relays for communicating with medical staff at a care facility. The mobile telemedicine device, where the interior portion of the main compartment comprises a shower and a toilet located in the interior portion of the main compartment. The mobile telemedicine device, where the one or more than one patient bed is at least 200 cm long and 80 cm wide. The mobile telemedicine device, further comprising one or more than one storage unit. The mobile telemedicine device, where the one or more than one storage unit comprises a viewer for viewing radiological images taken in the mobile radiological suite.

The mobile telemedicine device, further comprising a cooking area comprising a stove, a sink and a refrigerator. The mobile telemedicine device, further comprising a towed trailer; and where the towed trailer comprises medical supplies, communications equipment, food stores and fuel; and where the towed trailer comprises a hitch.

A method for using an all terrain mobile telemedicine vehicle that can carry supplementary telemedicine vehicles to remote locations for use in disasters and emergencies, the method comprising a) providing The mobile telemedicine device; and b) driving the mobile telemedicine device to a disaster or emergency location.

A method for using an all terrain mobile telemedicine vehicle that can carry supplementary telemedicine vehicles to remote locations for use in disasters and emergencies, the method comprising a) providing The mobile telemedicine device; b) driving the mobile telemedicine device to a disaster or emergency location; c) parking the mobile telemedicine device on a near-level surface; d) automatically leveling the mobile telemedicine device to true level; e) lowering the one or more than one supplemental vehicle from the storage compartment; f) deploying the one or more than one supplemental vehicle to search for one or more than one patient in need of immediate medical services; g) transmitting the one or more than one patient's medical history to the mobile telemedicine device; h) reviewing the one or more than one patient's medical history; i) treating the one or more than one patient at the current location; and j) transporting the one or more than one patient to the mobile telemedicine device for medical services.

### BRIEF DESCRIPTION OF THE DRAWINGS

These and other features, aspects and advantages of the present invention will become better understood with regard to the following description, appended claims, and accompanying figures where:

FIG. 1 is a schematic diagram of an all terrain mobile telemedicine vehicle that can carry supplementary telemedicine vehicles to remote locations for use in disasters and emergencies according to one embodiment of the present invention;

FIG. 2 is a top view of the schematic diagram of FIG. 1;

FIG. 3 is a picture of a motorcycle that can be used as a supplemental vehicle according to one embodiment of the present invention;

FIG. 4 is a picture of an all-terrain vehicle that can be used as a supplemental vehicle according to one embodiment of the present invention.

### DETAILED DESCRIPTION

According to one embodiment of the present invention, there is provided an all terrain mobile telemedicine vehicle (MTV) that can carry supplementary telemedicine vehicles to remote locations for use in disasters and emergencies. According to another embodiment of the present invention, there is provided a method for using the MTV in disasters and emergencies. In one embodiment, the method comprises, providing a device according to the present invention. The device and method will now be disclosed in detail.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by its intended use.

As used in this disclosure, except where the context requires otherwise, the term “comprise” and variations of the term, such as “comprising”, “comprises” and “comprised” are not intended to exclude other additives, components, integers or steps.

The terms e-health and tele-health are at times wrongly interchanged with telemedicine. Similar to the confusion between the terms “medicine” and “health care,” telemedicine refers only to the provision of clinical services while the term tele-health can refer to clinical and non-clinical services such as medical education, administration, and research. The term e-health is used as an umbrella term including tele-health, electronic medical records, and other components of health information technology, particularly in the United Kingdom and Europe. An example of a tele-health vehicle is the Mobile Telemedicine Unit (MTU) by the V-Tana Group that provides the basic clinical service elements of tele-health to support mass diagnosis of tuberculosis, HIV, malaria and infectious diseases; and the MTU can also be used as an information center to provide distant training on social and health related issues.

The term all-terrain vehicle (ATV) is used to describe any of a number of small, open, motorized buggies and motorized tricycles designed for off-road use with a single operator.

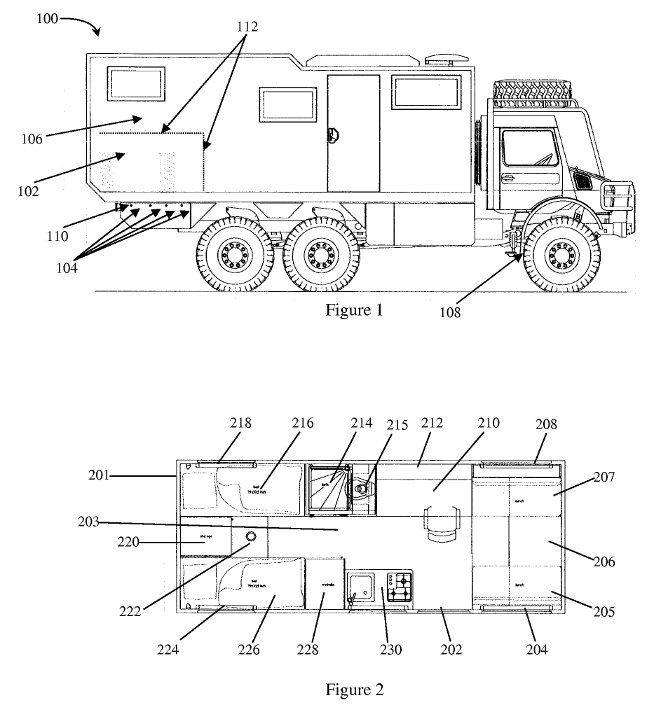

Referring now to FIG. 1 there is shown a schematic diagram of a mobile telemedicine vehicle (MTV) 100 for use in disasters and emergency response according to one embodiment of the present invention. The MTV 100 comprises four or more wheels with a drive train allowing the four or more wheels to receive power from an engine simultaneously. In a preferred embodiment, the MTV 100 comprises a six-wheel vehicle with a drive train that allows all six wheels to receive power from the engine simultaneously. In another preferred embodiment, the MTV 100 comprises a four-wheel drive vehicle with a drive train that allows all four wheels to receive power from the engine simultaneously. In one embodiment, the MTV 100 comprises a trailer hitch 110 attached to the rear of the MTV 100 for towing one or more than one supplemental vehicle or a mobile container hospital to expand the capabilities of the MTV 100. In a preferred embodiment, there is provided a supplemental compartment 102 that can transport one or more than one supplemental vehicle. In a particularly preferred embodiment, the one or more than one supplemental vehicle is a motorcycle 300. In another particularly preferred embodiment, the one or more than one supplemental vehicle is an ATV 400. In another embodiment, the supplemental compartment 102 comprises a hydraulic lift (not shown) to raise and lower the supplemental vehicles. In one embodiment, the supplemental compartment 102 comprises a medical laboratory for conducting medical tests. In a particularly preferred embodiment, the supplemental compartment 102 comprises an integrated radiology laboratory suite for taking X-Rays. In another embodiment, the MTV 100 comprises one or more than one wall 112 between the supplemental compartment 102 and the remainder of the vehicle wherein the wall comprises a lead shield/lining to protect the occupants of the MTV 100 from radiation. In one embodiment, the MTV 100 comprises automatic leveling hydraulic jacks 108 to level the MTV 100 on uneven surfaces. In one embodiment, the MTV 100 can be used as a base camp and can provide care for up to 1,000 people per MTV 100 with a crew of 3 comprising doctors, nurses and technicians or other medical personnel appropriate for the disaster or emergency. In one embodiment, the MTV 100 comprises one or more than one communications port 104 connected to the exterior portion 201 for connecting telemedicine devices to the MTV 100. In one embodiment, the communications ports are wireless and the telemedicine devices are wireless. In another embodiment, the communications ports 104 are wired and the telemedicine devices are wired. In a preferred embodiment, the communications ports 104 are both wired and wireless and the telemedicine devices are both wired and wireless.

Referring now to FIG. 2 there is shown a top view of the schematic diagram of FIG. 1. In one embodiment, the MTV 100 comprises a door 202 located on the main compartment 203. In one embodiment, the door 202 is 80 to 100 cm wide. In a preferred embodiment, the door 202 is 84 cm wide. One or more of the flat panel displays 204, 208, 212, 218 and 224 are attached to the interior portion 203 of the main compartment 106 of the MTV 100 for displaying information. In a preferred embodiment, the one or more of the flat panel displays 204, 208, 216, 218 and 226 are attached to a wall on the interior portion 203 of the main compartment 106 with a pivoting wall mount. In a particularly preferred embodiment, two or more of the one or more of the flat panel displays 204, 208, 216, 218 and 226 are located opposite each other for clear viewing by medical staff. In another embodiment, the one or more of the flat panel displays 204, 208, 216, 218 and 226 can display an operational status, contents of one or more than one flat panel display, or both operational status and the contents of one or more than one flat panel display for monitoring patient status. In another embodiment, the one or more of the flat panel displays 204, 208, 216, 218 and 226 further comprise one or more than one remotely controllable camera attached to the one or more of the flat panel displays 204, 208, 216, 218 and 226 for remote viewing of the interior portion 203 of the main compartment 106. One or more than one patient care table 206 comprises a telescopic arm that electronically raises and lowers the patient care table up and down. The one or more than one patient care table 206 is hingedly affixed to a wall in the interior portion 203 of the main compartment 106 for performing patient care in the MTV 100. The one or more than one patient care table 206 can be stored in an upright position allowing one or more than one patient to sit upright on the two benches 205 and 207. The two benches 205 and 207 comprise storage areas for holding supplies such as, for example, medical supplies. The one or more of the flat panel displays 204 and 208 are located opposite each other for clear viewing by medical staff. One or more than one communications center 210 comprises redundant computers and redundant satellite communication relays for communicating medical staff at a care facility, such as, for example, a primary care facility. The interior portion 203 of the main compartment 106 comprises a shower 214 and a toilet 215 located in the interior portion of the main compartment. In one embodiment, the one or more patient beds 216 and 226 are elevated and placed over the supplemental compartment 102. In one embodiment, the one or more patient beds 216 and 226 are used for patient recovery. In another embodiment, one or more patient beds 216 and 226 are used by the crew for sleeping during extended operations of the MTV 100. In a preferred embodiment, one or more than one patient bed is at least 200 cm long and 80 cm wide. In another embodiment, the MTV 100 further comprises one or more than one storage unit 220. Optionally, the one or more than one storage unit 220 is located between the one or more patient beds 216 and 226 to store supplies. Access hatch 222 is located on the rear floor of the MTV 100 to provide access to the supplemental compartment 102. In one embodiment, the access hatch is large enough to allow a medical cot at least 200 cm long and 80 cm wide to transit. In one embodiment, one or more than one storage unit 228 is provided for storage. In a preferred embodiment, the one or more than one storage unit 228 comprises a viewer for viewing radiological images taken in the mobile radiological suite. A cooking area 230 comprising a stove, a sink and a miniature refrigerator is provided to prepare meals for patients and medical staff. Optionally, one or more than one cabinet (not shown) can be affixed to the interior of the MTV 100 to provide extra storage or for housing medical equipment. In one embodiment, the MTV 100 further comprises a towed trailer (not shown). In another embodiment, the towed trailer (not shown) comprises medical supplies, communications equipment, food stores and fuel.

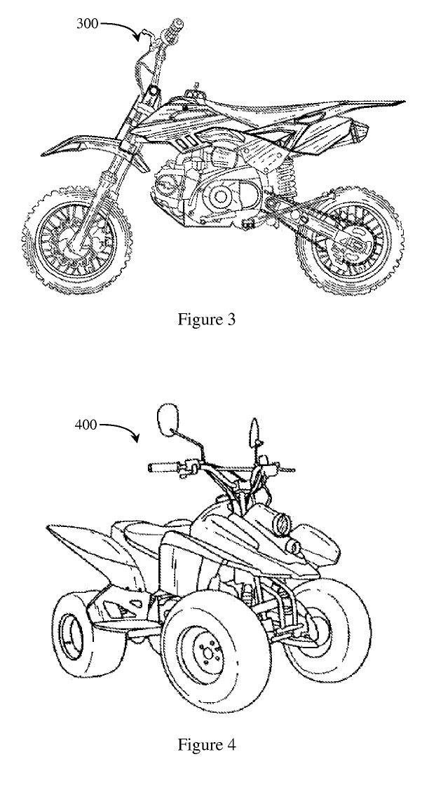

Referring now to FIG. 3 there is shown a picture of a motorcycle 300 that can be used as a supplemental vehicle according to one embodiment of the present invention. In one embodiment, the motorcycle 300 can be equipped with wired or wireless communications devices (not shown) for transmitting information back to the MTV 100 thereby extending the geographical range of medical coverage provided by the MTV 100. In another embodiment, the MTV 100 can be equipped with a remote controlled helicopter with video relay capabilities for forward surveillance and search ops extending the geographical range of medical coverage provide by the MTV 100. In one embodiment, the wireless communications devices are radio frequency. In a preferred embodiment, the wireless communications devices are satellite wireless communications devices.

Referring now to FIG. 4 there is shown a picture of an ATV that can be used as a supplemental vehicle according to one embodiment of the present invention. In one embodiment, the ATV 400 can be equipped with wireless communications devices for transmitting information back to the MTV 100 thereby extending the geographical range of medical coverage provided by the MTV 100. In one embodiment, the wireless communications devices are radio frequency. In a preferred embodiment, the wireless communications devices are satellite wireless communications devices. In one embodiment, the ATV 400 comprises a towed trailer that contains medical supplies, communications equipment, food stores and fuel. In another embodiment, the ATV 400 comprises a towed trailer for transporting patients to the MTV 100 for medical services or to a pick-up point to transfer the patient to a primary care facility.

According to another embodiment of the present invention, there is provided a method for using an all terrain mobile telemedicine vehicle that can carry supplementary telemedicine vehicles to remote locations for use in disasters and emergencies. In one embodiment, the method comprises, first, providing an all terrain mobile telemedicine vehicle that can carry supplementary telemedicine vehicles to remote locations for use in disasters and emergencies. Then, the MTV 100 is driven to a disaster or emergency location. Next, the MTV 100 is parked on a near-level surface. Then, the automatic leveling jacks adjust the MTV 100 to true level. Next, the one or more than one supplemental vehicle is lowered from the storage compartment. Then, the one or more than one supplemental vehicle is deployed. Next, the one or more than one supplemental vehicle scouts the surrounding area for people in need of immediate medical services. Then, the one or more than one supplemental vehicle operator sends the one or more than one patient's medical history to the MTV 100. Next the one or more than one patient's medical history is reviewed and the patient is either 1) treated at the current location or transported back to the MTV 100 for more medical services.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference in their entirety.

What is claimed is:

1. A mobile telemedicine device comprising:
a) four or more wheels connected to a drive train which is connected to an engine that provides the four or more wheels power from an engine simultaneously;
b) a main compartment connected to the four or more wheels, the main compartment comprising an interior portion and an exterior portion;
c) a supplemental compartment connected to the main compartment;
d) one or more than one automatic leveling hydraulic jack connected to the exterior portion of the main compartment;
e) one or more than one communications port connected to the exterior portion of the main compartment, and further connected to the supplemental compartment;
f) one or more than one patient care table affixed to the interior portion of the main compartment;
g) one or more than one communications center connected to the interior portion of the main compartment; and
h) one or more than one patient bed affixed to the interior portion of the main compartment.

2. The device of claim 1, where the four or more wheels is six wheels; and where the six wheels receive power from the engine simultaneously.

3. The device of claim 1, further comprising an access hatch located in the main compartment that provides access to the supplemental compartment.

4. The device of claim 3, where the access hatch is large enough to allow a medical cot at least 200 cm long and 80 cm wide to transit.

5. The device of claim 1, further comprising a trailer hitch attached to the supplemental compartment.

6. The device of claim 1, where the supplemental compartment comprises one or more than one supplemental vehicle.

7. The device of claim 6, where the one or more than one supplemental vehicle is selected from the group consisting of a motorcycle, a remote controlled helicopter and an ATV.

8. The device of claim 7, where the remote controlled helicopter comprises video relay means for forward surveillance and search operations.

9. The device of claim 6, where the one or more than one supplemental vehicle is equipped with one or more than one wired communications device, one or more than one wireless communications device or both one or more than one wired and one or more than one wireless communications device for transmitting information back to the mobile telemedicine device.

10. The device of claim 6, where the supplemental compartment comprises a hydraulic lift.

11. The device of claim 1, where the supplemental compartment is a medical laboratory for conducting medical tests.

12. The device of claim 1, where the supplemental compartment is an integrated radiology laboratory suite.

13. The device of claim 12, where one or more than one wall between the supplemental compartment and the main compartment comprises a lead shield, a lead lining or both a lead shield and a lead lining configured to protect the occupants of the mobile telemedicine device from radiation.

14. The device of claim 1, where the one or more than one communications port is wireless.

15. The device of claim 14, where the wireless communications port comprises a radio frequency communications device.

16. The device of claim 14, where the wireless communications port is a satellite wireless communications device.

17. The device of claim 1, where the one or more than one communications port is wired.

18. The device of claim 1, where or the one or more than one communications port is both wired and wireless.

19. The device of claim 1, further comprising a door located on the main compartment that comprises a width between 80 cm to 100 cm.

20. The device of claim 19, where the door is at least 84 cm wide.

21. The device of claim 1, where the interior portion of the main compartment comprises one or more than one flat panel display for displaying information.

22. The device of claim 21, where the one or more than one flat panel display is attached to a wall on the interior portion of the main compartment with a pivoting wall mount.

23. The device of claim 21, where the one or more flat panel displays are two or more than two flat panel displays, and where two of the two or more than two flat panel displays located opposite each other for clear viewing by medical staff.

24. The device of claim 21, where the one or more than one flat panel display can display an operational status, contents of one or more than one flat panel display, or both operational status and the contents of one or more than one flat panel display for monitoring patient status.

25. The device of claim 21, further comprising one or more than one remotely controllable camera attached to the one or more than one flat panel display for remote viewing of the interior portion of the main compartment.

26. The device of claim 1, where the one or more than one patient care table comprises a telescopic arm that raises and lowers the one or more than one patient care table.

27. The device of claim 1, where the one or more than one patient care table is hingedly affixed to a wall in the interior portion of the main compartment.

28. The device of claim 1, where the one or more than one communications center comprises redundant computers and redundant satellite communication relays for communicating with medical staff at a care facility.

29. The device of claim 1, where the interior portion of the main compartment comprises a shower and a toilet located in the interior portion of the main compartment.

30. The device of claim 1, where the one or more than one patient bed is at least 200 cm long and 80 cm wide.

31. The device of claim 1, further comprising one or more than one storage unit.

32. The device of claim 31, where the one or more than one storage unit comprises a viewer for viewing radiological images taken in the mobile radiological suite.

33. The device of claim 1, further comprising a cooking area comprising a stove, a sink and a refrigerator.

34. The device of claim 1, further comprising a towed trailer; and
where the towed trailer comprises medical supplies, communications equipment, food stores and fuel.

35. The device of claim 34, where the towed trailer comprises a hitch.

36. A method for using an all terrain mobile telemedicine vehicle that can carry supplementary telemedicine vehicles to remote locations for use in disasters and emergencies, the method comprising:
a) providing the device according to claim 1; and
b) driving the mobile telemedicine device to a disaster or emergency location.

37. A method for using an all terrain mobile telemedicine vehicle that can carry supplementary telemedicine vehicles to remote locations for use in disasters and emergencies, the method comprising:
a) providing the device according to claim 1;
b) driving the mobile telemedicine device to a disaster or emergency location;
c) parking the mobile telemedicine device on a near-level surface;
d) automatically leveling the mobile telemedicine device to true level;
e) lowering the one or more than one supplemental vehicle from the storage compartment;
f) deploying the one or more than one supplemental vehicle to search for one or more than one patient in need of immediate medical services;
g) transmitting the one or more than one patient's medical history to the mobile telemedicine device;
h) reviewing the one or more than one patient's medical history;
i) treating the one or more than one patient at the current location; and
j) transporting the one or more than one patient to the mobile telemedicine device for medical services.
